(19) United States
(12) Patent Application Publication
(10) Pub. No.: US 2025/0364756 A1
(43) Pub. Date: Nov. 27, 2025

(54) VIBRATION RESISTANT RIGHT ANGLE HEADER ELECTRICAL CONNECTOR

(71) Applicant: Aptiv Technologies AG, Schaffhausen (CH)

(72) Inventors: Gert DROESBEKE, Erkrath (DE); Jean RAZAFIARIVELO, RAMBOUILLET (FR); Thomas REINDERS, Wuppertal (DE); Sang-Jun PARK, Chungcheongnam-do (KR); Moon Sik KANG, Gyeonggi-do (KR); Tae Kwon YUK, Incheon (KR)

(21) Appl. No.: 19/214,272

(22) Filed: May 21, 2025

Related U.S. Application Data
(60) Provisional application No. 63/650,496, filed on May 22, 2024.

(30) Foreign Application Priority Data
May 21, 2025 (EP) 25177833

(51) Int. Cl. H01R 13/6585; H01R 12/72; H01R 13/6594; H01R 43/20

(52) U.S. Cl. CPC H01R 13/6585; H01R 12/724; H01R 13/6594; H01R 43/205

(57) ABSTRACT

A right-angle header electrical connector includes a housing and multiple signal terminals, each designed for right-angle connection to a printed circuit board. The connector further includes at least one shielding plate positioned between adjacent signal terminals. This shielding plate is shaped to essentially follow the contour of at least one signal terminal, providing electromagnetic shielding and reducing the impact of vibration on the signal terminals. The configuration enhances signal integrity and mechanical stability by decoupling the signal terminals from external vibrations and electromagnetic interference.

### CROSS-REFERENCE TO RELATED APPLICATION

This application claims the benefit of and priority to European Application No. 25177833 filed with the European Patent Office on May 21, 2025, which claimed the benefit of and priority to U.S. Provisional Application No. 63/650,496 filed on May 22, 2024, the contents of each of which are incorporated by reference herein.

### TECHNICAL FIELD

The present disclosure relates to relates to a right-angle header electrical connector with shielding plates and a method of assembling such connectors.

### BACKGROUND

In the field of electrical connectors, for instance those designed for right-angle connections to printed circuit boards (PCBs), it is common to employ multiple signal terminals arranged within an insulating housing. These connectors are widely used in a variety of electronic devices and systems, where efficient signal transmission and mechanical stability are important. Known systems typically involve the placement of signal terminals in proximity, which can lead to challenges such as electromagnetic interference (EMI) between adjacent terminals, as well as mechanical issues related to vibration and stress during operation or assembly. To address EMI, shielding solutions have been introduced, often in the form of separate shielding components or external enclosures. However, these approaches can increase the complexity of assembly, add to the overall size of the connector, and may not always provide sufficient decoupling between individual signal paths.

Additionally, the mechanical integrity of right-angle connectors is an important concern, particularly in applications subject to frequent vibration or mechanical shock. Conventional designs may not adequately address the risk of terminal deformation or loosening over time, which can compromise both electrical performance and reliability. The process of assembling such connectors, especially when incorporating shielding elements, can also be labor-intensive and prone to misalignment, further impacting yield and consistency in manufacturing. Despite the substantial advances in the field of right-angle electrical connectors, including improvements in contact geometry and housing materials, there remains a need for solutions that enhance both electromagnetic shielding and mechanical robustness without unduly complicating the assembly process or increasing connector size.

In view of the foregoing, there is a need to provide a right-angle header electrical connector that at least partially overcomes the disadvantages of known systems.

### SUMMARY

An aspect of the disclosure relates to a right-angle header electrical connector including: a housing; a plurality of signal terminals, each signal terminal being configured for right-angle connection to a printed circuit board; and at least one shielding plate disposed between adjacent signal terminals, wherein the shielding plate essentially follows the shape of at least one of the signal terminals, configured to provide electromagnetic shielding and to decouple the signal terminals from vibrations, for instance transmitted through the housing or the PCB.

With such a right-angle header connector, the shielding plates enhance the overall performance by minimizing electromagnetic crosstalk between adjacent terminals. The shielding plate is shaped to closely follow the contour of at least one signal terminal, which enhances its effectiveness in providing electromagnetic shielding and reduces electromagnetic interference between terminals. Additionally, the shielding plate is configured to mechanically decouple the signal terminals from vibration, thereby improving the connector's resistance to mechanical stress and vibration-induced failures.

Further improvement is achieved when at least one signal terminal is formed as a male pin configured to be soldered and/or press-fit into the printed circuit board.

With such a terminal a direct mechanical and electrical interface between the connector and the board can be established. Press-fit pins can simplify automated production by eliminating the need for soldering, which is useful in high-volume manufacturing. Alternatively, soldered connections provide a more permanent and secure bond in applications where mechanical stress or vibration is a concern. This design choice supports configurability across various production environments while ensuring strong electrical contact and mechanical stability.

Further improvement is achieved when the shielding plate includes a generally planar main body extending parallel to a plane defined by the longitudinal extension of the terminals and the mating direction of the connector.

With such a planar design of the shielding plate it aligns effectively with the signal path and mating interface of the connector. By positioning the shielding surface in a plane parallel to the plane of the signal flow and connection direction, the structure optimizes electromagnetic shielding performance. It helps reduce crosstalk and external EMI while maintaining a compact form factor. The planar configuration of the shielding plate also facilitates more effective coverage and separation between adjacent terminals, improving the overall integrity and performance of the connector in environments where precise signal integrity and mechanical stability are required.

Further improvement is achieved when at least one terminal includes a first and a second bend, forming a first terminal inner angle and a second terminal inner angle, such that the sum of the first and the second angle is 270 degrees.

With such a terminal a two-bend configuration allows the terminal to achieve a compact right-angle profile while maintaining optimal mechanical stress distribution. The combined 270-degree angle layout can help route the terminal efficiently through the housing and toward the PCB. This geometry can also support better alignment and insertion accuracy, which is beneficial in automated assembly processes. Moreover, the precise angular control may enhance signal integrity by maintaining consistent impedance along the terminal path.

This can be further improved when the shielding plate includes a first bend forming a first shielding inner angle corresponding to the first terminal inner angle, and a second bend forming a second shielding inner angle corresponding to the second terminal inner angle.

Such a shielding plate can ensure that the shielding plate closely conforms to the geometry of the signal terminal, enhancing the electromagnetic shielding effect by minimizing gaps and providing a more continuous barrier. The bends also improve mechanical stability and vibration decoupling.

This can be further improved when the first terminal inner angle is between 100 and 170 degrees, preferably between 120 and 150 degrees, most preferred 135 degrees.

Such an angle can refine the mechanical and electrical interface between the signal terminals and the printed circuit board, improving the spatial arrangement and mechanical stability of the connector. By defining an inner angle of e.g. 135 degrees, the implementation can ensure improved signal transmission and mechanical decoupling, enhancing the connector's performance in terms of electromagnetic shielding and resistance to vibration.

Further improvement is achieved when the shielding plate includes at least one push edge configured to facilitate insertion of the shielding plate in the printed circuit board.

Such a push edge can reduce the risk of misalignment or mechanical damage during assembly, for instance in automated production lines. The push edge can also ensure secure engagement of the shielding plate with the board, contributing to mechanical stability and consistent grounding for EMI protection.

Further improvement is achieved when the shielding plate includes a first shoulder configured to facilitate insertion shielding plate in the housing.

Such a shoulder can simplify the installation process and help maintain consistent alignment, which is important for reliable electrical performance and mechanical stability. It can also reduce the likelihood of damage to the shielding plate or the housing during insertion. This addition improves manufacturability and reliability by simplifying assembly and reducing the risk of misalignment or displacement.

Further improvement is achieved when the shielding plate includes a first shoulder configured to facilitate insertion of the shielding plate in the housing, wherein the first shoulder is arranged on the shielding plate close to the housing in mated condition.

With a first shoulder positioned on the shielding plate near the housing when the connector is in the mated condition, the mechanism of communication between the shielding plate and the housing is thus enhanced by this first shoulder, as it provides a physical interface that guides and stabilizes the shielding plate during assembly. This feature improves the reliability of the shielding plate's placement and ensures consistent electromagnetic shielding and vibration decoupling.

This can be further improved when the first shoulder includes one or more tongues that are bent in a direction perpendicular to the mating direction, configured to facilitate insertion of the shielding plate into the housing.

One or more tongues that are bent perpendicular to the mating direction can establish a mechanical interaction between the shielding plate and the housing, where the tongues can act as guiding or locking elements to facilitate and secure the insertion of the shielding plate into the housing. The tongues can also be a means to push onto, to drive and assemble the shielding plate within the housing.

Further improvement is achieved when the shielding plate includes a second shoulder configured to facilitate insertion shielding plate in the housing, wherein the second shoulder is arranged on the shielding plate close to the terminal ends.

Such a second shoulder can establish a mechanical interface between the shielding plate and the housing, ensuring precise alignment and secure placement during assembly. By providing this additional structural element, the implementation can enhance the case and reliability of manufacturing and assembly processes, while also improving the stability of the shielding plate within the connector.

Further improvement is achieved when the shielding plate includes rounded corners, configured to decrease mechanical stress at the corners of the shielding plate.

Incorporating rounded corners into the shielding plate can improve the mechanical durability of the component, especially during assembly and operation in vibration-prone environments. Rounded edges help distribute stress more evenly, reducing the risk of cracking or deformation over time. Smoother contours also minimize the chance of damage to nearby components or to insulation layers on signal terminals during assembly.

Another aspect of the disclosure relates to a method for assembling a right-angle header electrical connector, the method including providing a housing with a plurality of signal terminals arranged within the housing and further providing a printed circuit board and at least one shielding plate; positioning at least one shielding plate between adjacent signal terminals; and inserting the at least one shielding plate into the housing; mating the shielding plate and the terminals with the printed circuit board.

Such a method can supports a structured and efficient assembly process for right-angle connectors used in electronic systems. By inserting the shielding plate between terminals before mating with the PCB, the method ensures optimal placement for EMI shielding and mechanical stability. This process is suited for automated production lines and enhances consistency across manufactured units. It also minimizes the risk of misalignment or poor contact during installation.

This can be further improved when the shielding plate is provided with at least one push edge and/or shoulder to facilitate insertion into the housing and/or into the printed circuit board.

Using a shielding plate with integrated push edges or shoulders simplifies and accelerates the insertion process during assembly. These features act as guides or mechanical aids, helping to ensure proper alignment and seating of the shielding plate within the connector housing and the PCB. This can reduce the chance of assembly errors, improve production efficiency, and can enhance the mechanical reliability of the final connector.

This can be further improved when the shielding plate essentially follows the shape of at least one of the signal terminals and is arranged adjacent to at least one signal terminal and with rounded corners.

Forming the shielding plate to mirror the shape of a signal terminal ensures optimal proximity for electromagnetic shielding and improves mechanical integration. The adjacent placement enhances signal isolation, while the rounded corners help prevent stress concentrations that could lead to material fatigue or cracking over time. The method also promotes consistent assembly quality, for instance when used in conjunction with automated manufacturing systems.

### BRIEF DESCRIPTION OF THE DRAWINGS

In the following, preferred embodiments of the disclosure are disclosed by reference to the accompanying figures.

FIG. 1 shows a cross-sectional side view of a prior art right-angle header electrical connector according to the prior art.

FIG. 2 shows a cross-sectional side view of an embodiment of a right-angle header electrical connector according to some embodiments.

FIG. 3: shows an isometric view of a right-angle header electrical connector according to some embodiments.

FIG. 4 shows a side view of a shielding plate for a right-angle header electrical connector according to some embodiments.

FIG. 5A shows a side view of a shielding plate with a shoulder and bent tongues according to some embodiments.

FIG. 5B shows a cross-sectional view (section line B-B of FIG. 5A) of the shielding plate of FIG. 5A according to some embodiments.

FIG. 6 shows a schematic flowchart illustrating an embodiment of a method for assembling a right-angle header electrical connector according to some embodiments.

### DETAILED DESCRIPTION

The subsequent sections provide a detailed description of embodiments of the invention, referencing the accompanying illustrations for clarity. The descriptions represent examples only and are not intended to limit the invention's scope in any way. Identical reference numerals are sued across the figures and text to denote the same components. The illustrations may not reflect actual size or scale; their dimensions, proportions, and depictions of elements might be enhanced for better understanding and visual convenience.

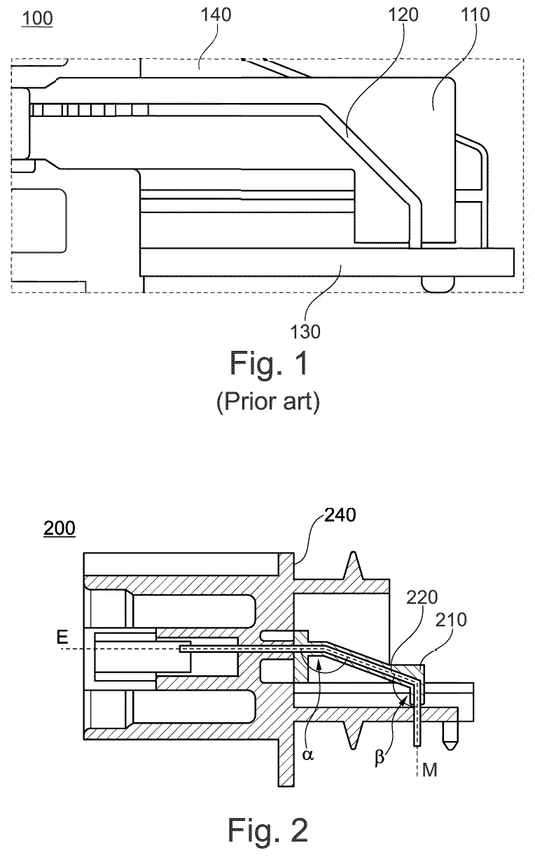

FIG. 1 illustrates a prior right-angle header electrical connector 100 including a housing 140, a signal terminal 120, and a shielding plate 110. The signal terminal 120 is arranged within housing 140 and is configured for right-angle connection to a printed circuit board 130. Shielding plate 110 is positioned adjacent to the signal terminal 120 and extends through housing 140 to the printed circuit board 130. The prior art connector faces some disadvantages: Straight or single-bend terminals do not optimize mechanical decoupling or stress distribution, increasing the risk of terminal fatigue or failure. Additionally, these prior art connectors do not provide features such as push edges or shoulders to facilitate reliable insertion and assembly, complicating manufacturing and reducing robustness in high-density applications. Additionally, the shielding area is not optimized for impedance matching and electromagnetic shielding.

FIG. 2 shows an embodiment of a right-angle header electrical connector 200. Housing 240 encloses signal terminal 220 and shielding plate 210. Shielding plate 210 is disposed adjacent to signal terminal 220 and follows its bent profile, providing electromagnetic shielding and vibration decoupling within the housing 240. The shielding plate 210 essentially follows the shape of at least one of the signal terminals 220, configured to provide electromagnetic shielding and to decouple the signal terminals from vibration. The signal terminal 220 is formed as a male pin configured to be soldered and/or press-fit into a printed circuit board (not shown). The terminal 220 includes a first and a second bend, forming a first terminal inner angle α of about 150 degrees and a second terminal inner angle β of about 120 degrees, such that the sum of the first and the second angle is 270 degrees. The shielding plate 210 includes a first bend forming a first shielding inner angle corresponding to the first terminal inner angle α of 150 degrees and a second bend forming a second shielding inner angle corresponding to the second terminal inner angle β of 120 degrees. The shielding plates 210 include a generally planar main body extending parallel to a plane defined by the longitudinal extension E of the terminals 220 and the mating direction M of the connector 200.

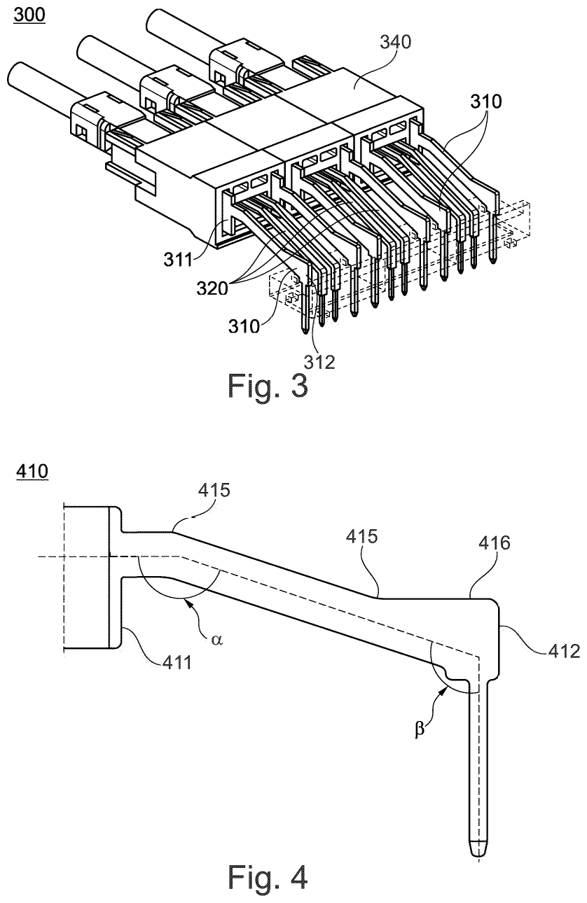

FIG. 3 illustrates an embodiment of a right-angle header electrical connector 300. Housing 340 accommodates multiple signal terminals 320 arranged for right-angle connection to a printed circuit board (not shown). Shielding plates 310 are disposed between adjacent signal terminals 320, following the bent geometry of the terminals and extending through the housing 340 toward the board interface. The shielding plates 310 provide electromagnetic shielding and mechanical decoupling between the signal terminals 320. The shielding plates 310 and signal terminals 320 oriented to facilitate insertion into a printed circuit board (not shown). The first shoulder 311 is arranged on the shielding plate 310 close to the housing 340 in mated condition. The second shoulder 312 is configured to facilitate insertion shielding plate in the housing 340 and the second shoulder 312 is arranged on the shielding plate 310 close to the terminal ends.

FIG. 4 illustrates shielding plate 410 featuring a first shoulder 411 and a second shoulder 412. The main body of shielding plate 410 extends at a right angle, defined by inner angles α (around 150 degrees) and β (around 120 degrees). Push edge 416 is positioned near the second shoulder 412 to facilitate insertion into a PCB (not shown). The configuration of shielding plate 410, including the bends at α and β, allows it to closely follow the path of an adjacent signal terminal (not shown), providing both electromagnetic shielding and mechanical decoupling from vibration. The push edge 416 is configured to facilitate insertion of the shielding plate in the printed circuit board. The first shoulder 411 is configured to provide a surface into which for instance an assembler or an assembling machine can exert force onto, thus facilitating insertion of the shielding plate in the housing. The shielding plate 410 includes rounded corners 415, configured to decrease mechanical stress at the corners of the shielding plate.

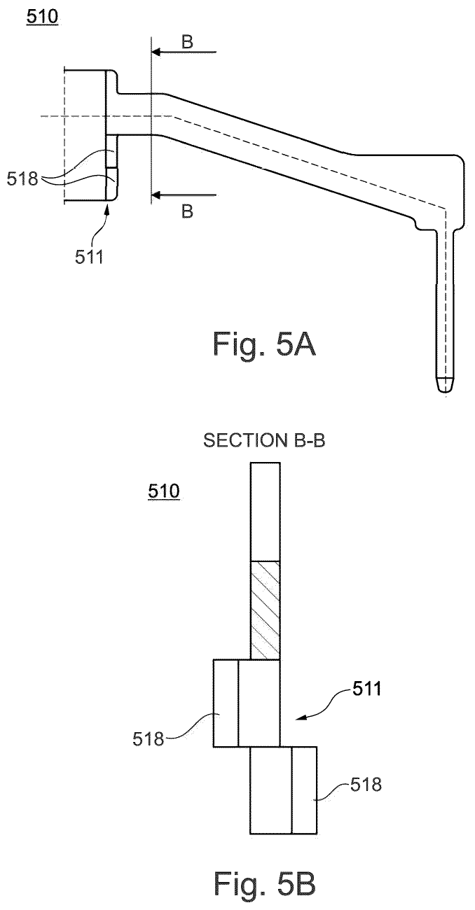

FIG. 5A shows a shielding plate 510 configured for a right-angle header electrical connector. Shielding plate 510 includes first shoulder 511 positioned near the housing interface, with tongues 518 bent perpendicularly to the mating direction to facilitate insertion into the housing. The shielding plate geometry follows a bent profile, and section line B-B indicates a cross-sectional view through the shoulder and tongue region. The arrangement of tongues 518 on shoulder 511 is designed to enhance mechanical retention and alignment and provides a dedicated area onto which an operator or assembler can exert force during assembly.

FIG. 5B illustrates a sectional view B-B of shielding plate 510. The shielding plate 510 is shown with tongues 518, which are bent in a direction perpendicular to the mating direction. The tongues 518 are extending laterally from the main body of the shielding plate 510, facilitating insertion and retention within the connector housing. The first shoulder 511 includes two tongues 518 that are bent in a direction perpendicular to the mating direction, configured to facilitate insertion of the shielding plate into the housing (not shown).

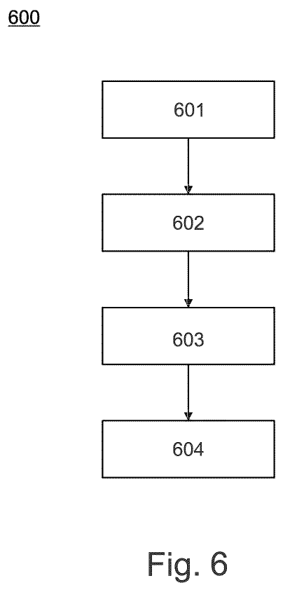

FIG. 6 illustrates a flowchart 600 depicting a method for assembling a right-angle header electrical connector. The process starts at step 601 by providing a housing with a plurality of signal terminals arranged within the housing and further providing a printed circuit board and at least one shielding plate. This is followed by step 602 which includes positioning at least one shielding plate between adjacent signal terminals. This is followed by step 603 including inserting the at least one shielding plate into the housing. Step 604 concludes the method by mating the shielding plate and the terminals with the printed circuit board.

The method can be improved when the shielding plate is provided with at least one push edge and/or shoulder to facilitate insertion into the housing and/or into the printed circuit board.

The method can be further improved when the shielding plate essentially follows the shape of at least one of the signal terminals and is arranged adjacent to at least one signal terminal and with rounded corners.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LIST OF REFERENCE NUMBERS

100, 200, 300 right-angle header electrical connector
110, 210, 310, 410, 510 shielding plate
120, 220, 320 signal terminal
130 printed circuit board
140, 240, 340 housing
411, 511 first shoulder
412 second shoulder
415 rounded corners
416 push edge
518 tongues
600 method
601, 602, 603, 604 method steps

1. A right-angle header electrical connector, comprising:
a housing;
a plurality of signal terminals, each signal terminal being configured for right-angle connection to a printed circuit board; and
at least one shielding plate disposed between adjacent signal terminals, wherein the shielding plate essentially follows the shape of at least one of the signal terminals, configured to provide electromagnetic shielding and to decouple the signal terminals from vibration.

2. The electrical connector according to claim 1, wherein at least one signal terminal is formed as a male pin configured to be soldered into the printed circuit board.

3. The electrical connector according to claim 1, wherein at least one signal terminal is formed as a male pin configured to be press-fit into the printed circuit board.

4. The electrical connector according to claim 1, wherein the shielding plate comprises a generally planar main body extending parallel to a plane defined by the longitudinal extension of the terminals and the mating direction of the connector.

5. The electrical connector according to claim 1, wherein at least one terminal comprises a first and a second bend, forming a first terminal inner angle and a second terminal inner angle, such that the sum of the first and the second angle is 270 degrees.

6. The electrical connector according to claim 5, wherein the shielding plate comprises a first bend forming a first shielding inner angle corresponding to the first terminal inner angle, and a second bend forming a second shielding inner angle corresponding to the second terminal inner angle.

7. The electrical connector according to claim 5, wherein the first terminal inner angle is between 100 and 170 degrees.

8. The electrical connector according to claim 7, wherein the first terminal inner angle is between 120 and 150 degrees.

9. The electrical connector according to claim 8, wherein the first terminal inner angle is 135 degrees.

10. The electrical connector according to claim 1, wherein the shielding plate comprises at least one push edge configured to facilitate insertion of the shielding plate in the printed circuit board.

11. The electrical connector according to claim 1, wherein the shielding plate comprises a first shoulder configured to facilitate insertion shielding plate in the housing.

12. The electrical connector according to claim 1, wherein the shielding plate comprises a first shoulder configured to facilitate insertion shielding plate in the housing, wherein the first shoulder is arranged on the shielding plate close to the housing in mated condition.

13. The electrical connector according to claim 12, wherein the first shoulder comprises one or more tongues that are bent in a direction perpendicular to the mating direction, configured to facilitate insertion of the shielding plate into the housing.

14. The electrical connector according to claim 1, wherein the shielding plate comprises a second shoulder configured to facilitate insertion shielding plate in the housing, wherein the second shoulder is arranged on the shielding plate close to the terminal ends.

15. The electrical connector according to claim 1, wherein the shielding plate comprises rounded corners, configured to decrease mechanical stress at the corners of the shielding plate.

16. A method for assembling a right-angle header electrical connector, the method comprising:
providing a housing with a plurality of signal terminals arranged within the housing and further providing a printed circuit board and at least one shielding plate;
positioning at least one shielding plate between adjacent signal terminals;
inserting the at least one shielding plate into the housing; and
mating the shielding plate and the terminals with the printed circuit board.

17. The method according to claim 16, wherein the shielding plate is provided with at least one push edge and/or shoulder to facilitate insertion into the housing and/or into the printed circuit board.

18. The method according to claim 16, wherein the shielding plate essentially follows the shape of at least one of the signal terminals and is arranged adjacent to at least one signal terminal and with rounded corners.
